(19) United States
(12) Patent Application Publication
(10) Pub. No.: US 2019/0045263 A1
(43) Pub. Date: Feb. 7, 2019

(54) STANDBY POWER CONTROLLER WITH IMPROVED STANDBY DETECTION

(71) Applicant: Embertec Pty Ltd, Dulwich (AU)

(72) Inventor: Riccardo Gatto, Dulwich (AU)

(21) Appl. No.: 15/791,789

(22) Filed: Oct. 24, 2017

(30) Foreign Application Priority Data
Aug. 7, 2017 (AU) 2017903121

(51) Int. Cl. H04N 21/443; H04L 29/06; H02J 13/00; H04N 5/63; H04N 21/422; H04N 21/442

(52) U.S. Cl. CPC H04N 21/4436; H04L 69/22; H02J 13/0075; H04W 4/008; H04N 21/42207; H04N 21/42221; H04N 21/44227; H04N 5/63

(57) ABSTRACT

A standby power controller including an electrical outlet which supplies electrical power to a television which display a video signal provided by a set top box. There is a sensor which senses use of a remote control device which is used to perform user-initiated control of the set top box. The sensor is adapted to distinguish signals travelling between the remote control device and the set top box which are associated with user-initiated control of the set top box from signals travelling between the remote control device and the set top box which are not associated with user-initiated control of the set top box, and the standby power controller removes power from the television in the event that the sensor does not detect user-initiated control of the set top box for a selected time period.

### FIELD OF THE INVENTION

This invention relates to a standby power controller adapted for use with a set top box.

### BACKGROUND OF THE INVENTION

The following references to and descriptions of prior products or other matter are not intended to be, and are not to be construed as, statements or admissions of common general knowledge in the art. In particular, the following prior art discussion does not relate to what is commonly or well known by the person skilled in the art, but may assist in the understanding of the present invention.

There is currently world-wide concern about the level of use of electrical energy for both domestic and commercial purposes. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households is the audio visual equipment including multiple devices such as televisions, television decoders, television recorders and sound equipment now found in virtually all homes.

Efforts have been made to reduce or control the use of energy by television receivers and associated audio visual equipment, in particular via the use of standby power controllers, and these efforts have met with considerable success. More advanced standby power controllers have been proposed which allow energy saving beyond that which can be achieved by removing the supply of electricity when the television is in a low power standby state. However, significant classes of audio visual installations are not compatible with these approaches.

### SUMMARY OF THE INVENTION

The invention involves a standby power controller including:

an electrical outlet which supplies electrical power to a television, the television being adapted to display a video signal provided by a set top box;

a sensor adapted to sense use of a remote control device, the remote control device being used to perform user-initiated control of the set top box;

wherein the sensor is adapted to distinguish between (1) signals travelling between the remote control device and the set top box which are associated with user-initiated control of the set top box, and (2) signals travelling between the remote control device and the set top box which are not associated with user-initiated control of the set top box;

the standby power controller operating to remove power from the television in the event that the sensor does not detect user-initiated control of the set top box for a selected time period.

Signals travelling between the remote control device and the set top box which are associated with user-initiated control of the set top box differ from signals travelling between the remote control device and the set top box which are not associated with user-initiated control of the set top box by one or more known characteristics which are detectable without knowledge of the command content of the signal. As an example, the signals travelling between the remote control device and the set top box which are not associated with user-initiated control of the set top box may have a known temporal distribution, wherein this temporal distribution is not shared by signals travelling between the remote control device and the set top box which are associated with user-initiated control of the set top box.

The standby power controller preferably distinguishes the two types of signals by ignoring signals having the known characteristic(s). In the foregoing example, the standby power controller might distinguish and ignore signals having the known temporal distribution.

Preferably, the distinguishing characteristic(s) are that the signals travelling between the remote control device and the set top box which are not associated with user-initiated control of the set top box have a known payload size which differs from the payload size of at least a majority of signals travelling between the remote control device and the set top box which are associated with user-initiated control of the set top box. The standby power controller can then distinguish and ignore signals having the known payload size.

The sensor preferably detects user-initiated control of the set top box by detecting the remote control device's usage of a wireless protocol to communicate control commands to the set top box.

The remote control device and the set top box preferably communicate by use of a wireless protocol which includes pairing between devices in order to permit communication between the devices. The sensor can then detect usage only when the sensor monitors signals passing between the remote control device and the set top box paired with the remote control device (and wherein the sensor is preferably not paired with either the remote control device or the set top box).

The wireless protocol may include packets having an unencrypted header and an encrypted payload. The standby power controller can then determine that a received packet is a communication between the remote control device and the set top box using information contained in the header, without use of information contained in the payload.

The wireless protocol may be of a type which includes an address for each device addressable by another device using the protocol, and where each packet intended for processing by a device includes the address of the device in a packet header of the packet. The standby power controller may then be adapted to determine the address of the set top box without pairing with the set top box or any remote control device.

The sensor is preferably further adapted to detect an infra-red signal from a remote control device associated with the television. The standby power controller might then remove power from the television associated with the set top box only in the event that the sensor does not detect user-initiated control of the set top box, and the sensor also does not detect an infra-red signal from the remote control device associated with the television, for a selected time period.

The invention also involves a method for saving energy by removing power from a television of a type which displays a video signal from a set top box when the television is not being actively watched by a user. The energy-saving method preferably includes the steps of:

detecting user-initiated control of the set top box by detecting use of a first wireless remote control adapted to control the set top box;

determining, where the user-initiated control is not detected for a selected period of time, that the user is not actively watching the television; and

upon determining that the user is not actively watching television, removing power from the television.

Preferably, the detecting step further includes the steps of:

determining an address of the set top box within a wireless protocol used to communicate between the set top box and the remote control;

monitoring all communications in the vicinity of the set top box (i.e., within 25 feet of the set top box) which use the wireless protocol;

examining address information in the monitored communications;

determining that the address information is the address of the set top box;

determining that the communication is a user-initiated control of the set top box; and

determining that user-initiated control of the set top box has been detected.

Preferably, the method further includes detecting use of a second wireless remote control adapted to control the television; and determining, where use of the first remote control is not detected for the selected period of time, and use of the second remote control is not detected for the selected period of time, that the user is not actively watching the television.

### BRIEF DESCRIPTION OF THE DRAWINGS

Exemplary versions of the invention will now be described with reference to the accompanying drawings, wherein:

FIG. 1 is a representation of a standby power controller incorporating the invention. FIGS. 2a and 2b (collectively referred to as FIG. 2) provide a block diagram representation of an RF detection arrangement that may be employed by the invention.

FIG. 3 is a flowchart of the operation of a standby power controller incorporating the invention.

FIG. 4 is a representation of an alternative version of the invention.

FIG. 5 is a flowchart of the possible operation of a version of the invention which includes an IR remote control detector.

FIG. 6 is a flowchart of the possible operation of a version of the invention which includes a power sensor.

### DETAILED DESCRIPTION OF EXEMPLARY VERSIONS OF THE INVENTION

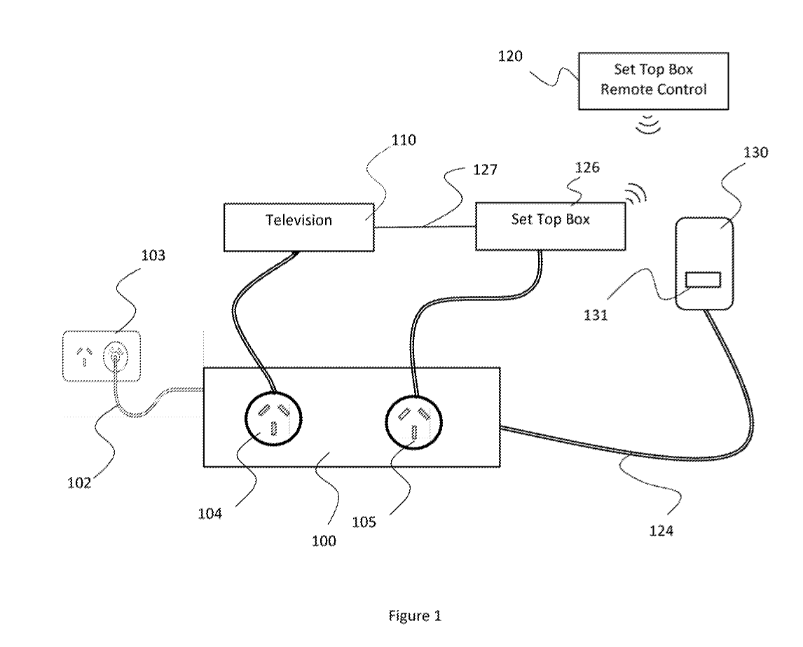

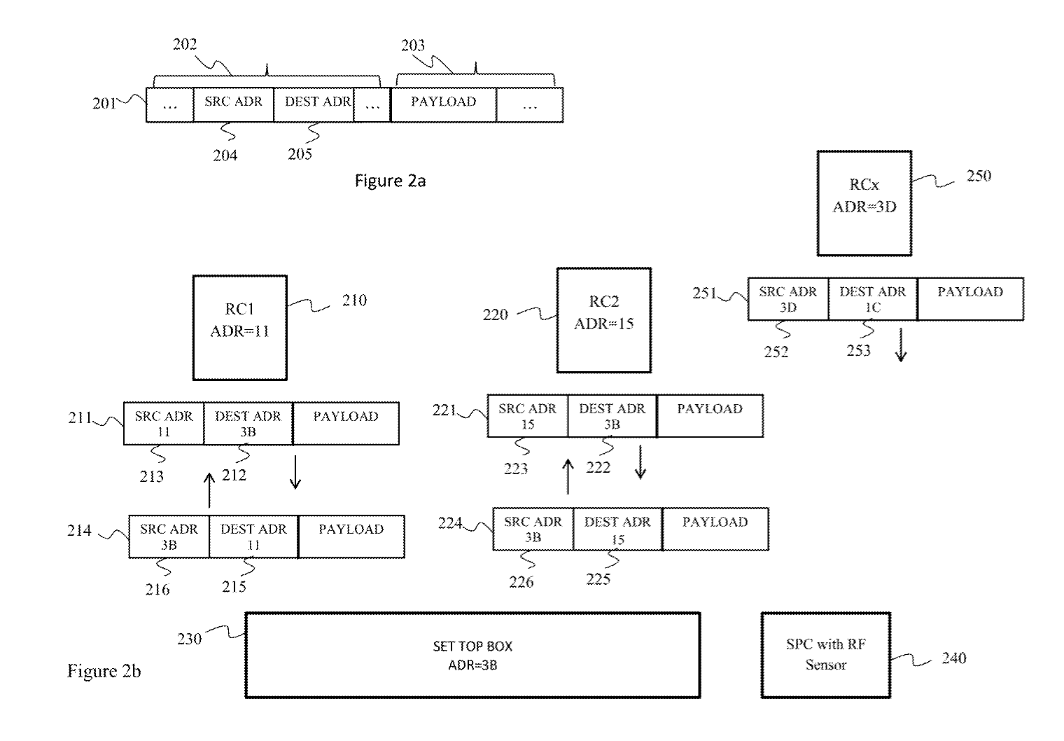

FIG. 1 provides a general representation of an installation including an exemplary standby power controller which embodies the invention. Because the invention encompasses all alternatives defined by the claims at the end of this document, and the drawings merely depict possible specific forms that the invention may assume, a standby power controller in accordance with the invention may differ from the one depicted. Thus, standby power controllers in accordance with the invention are not limited to the depicted number or configuration of continually powered or switched or monitored main outlets, or to the number or configuration of communication interfaces or other functional modules.

FIG. 1 shows a representation of a standby power controller exemplifying the invention. A standby power controller is a device which controls the flow of electrical power to one or more connected appliances such that when one or more, or a particular one, of the connected appliances is in a “standby” state where it is not being used, the electrical power supply to one, all, or selected ones of the connected appliances is interrupted. A standby power controller may also be known as an Advanced Power Strip (APS).

The standby power controller 100 receives electrical power from a General Purpose Outlet 103 via power cord 102.

The standby power controller 100 includes a Controlled Outlet 104 which provides electricity to a television 110. The standby power controller 100 controls the flow of electricity through the Controlled Outlet 104 and the flow may be interrupted independently of the electricity supply from the General Purpose Outlet 103.

An Always On Outlet 105 supplies electricity at any time when electricity is supplied to the standby power controller 100 from General Purpose Outlet 103. The Always On Outlet 105 may be used to power any device which requires constant power. In the illustrated version, the Always On Outlet 105 provides power to a set top box 126.

The set top box 126 provides a video signal to the television 110 via data connection 127. The data connection 127 is preferably an HDMI connection. Any suitable wired or wireless connection may be used. The term “set top box” includes, without limitation, a cable box, a digital television receiver/decoder, a satellite television receiver/decoder, and a pay TV receiver/decoder. The set top box 126 receives a television program signal via cable, satellite or interne connection, or any other suitable connection. The set top box 126 decodes the received program signal and displays the video on the television 110.

A user uses a set top box remote control 120 to control the set top box 126, to select the particular television channel to be displayed on the television 110. Other characteristics of the video to be displayed by the television 110, such as the volume of the sound, may also be controlled by the set top box remote control 120.

The set top box remote control 120 communicates with the set top box 126 via radio frequency (RF) signals. Any suitable protocol may be used. In a preferred version, the set top box remote control 120 communicates with the set top box 126 using the RF4CE protocol.

The standby power controller 100 includes a sensor unit 130, which includes an RF Sensor 131. The RF Sensor 131 is able to detect the RF communication between the set top box remote control 120 and the set top box 126.

The sensor unit 130 is shown as being in a separate housing from the base unit of the standby power controller 100 which supports the outlet connections. Functionally, the sensor unit 130 is an integral part of the standby power controller 100. In other versions, the sensor unit 130 may be fully integrated within the base unit of the standby power controller 100. In versions where there are separate housings for the base unit and the sensor unit 130, functional circuitry including processing and memory circuitry may be divided between the housings in any convenient manner. References to a standby power controller 100 herein include the sensor unit 130, whether or not housed separately.

Modern television sets and other audio visual equipment, when turned “off” by the remote control, enter a low power “standby” state, in which energy is still consumed, although at a significantly lower level that when the device is nominally “on”. When the television or other audio visual equipment is in this standby state it is not in use, and the power supply to it may be cut to save energy without inconvenience to a user.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy, without inconveniencing a user.

The standby power controller 100 includes means to detect that a user is interacting with the set top box 126. The sensor unit 130 includes RF Sensor 131 which detects interaction between the set top box 126 and the set top box remote control 120.

It is likely that a user, when actively watching television, will periodically use the remote control to change channels, adjust volume, mute commercials, etc. Thus a remote control signal receiver, such as RF Sensor 131, can be used as a usage sensor. In installations where most or all interactions between the remote control device and the set top box 126 indicate user-initiated control of the set top box 126, such as to change channels, detection of such interaction is sufficient to assume that user-initiated control of the set top box 126 is taking place. In installations where a significant amount of traffic between the set top box remote control 120 and the set top box 126 is related to functions other than user-initiated control of the set top box 126, further analysis will be needed to ensure that remote control activity is recognized substantially only when that activity is user-initiated control of the set top box 126.

If no user initiated remote control activity is detected by the RF Sensor 131 for a period of time, the assumption may be made that the television 110 is not in use, and the power supply to the Controlled Outlet 104, and hence to the television 110, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no user initiated remote control activity for the time period, and the television 110 is assumed to not be in active use. The electricity supply to the Controlled Outlet 104, and hence to the television 110, is then interrupted.

RF remote control devices have relatively long range and do not require line of sight between the remote control unit and the device to be controlled. This has the potential problem that a signal from a set top box remote control device may be received by a device other than that which the user intends to control. This can occur, for example, when there are multiple remote controllable devices in a household, and/or when dwellings are adjacent, as in an apartment block, and each dwelling has a similar set top box 126.

A solution to this problem which is generally implemented is for the signals emitted by the set top box remote control 120, intended for a specific set top box 126, to include an identifier identifying either or both of the sending and intended recipient devices. The receiving device will then only act upon received communications which include either the identifier of the receiving device itself, or that of a known sending device to which the receiving device is intended to respond. The set top box 126 and set top box remote control 120 are thus “paired”. This may be done at manufacture, and/or may be performed under user control.

The RF Sensor 131 is intended to respond only to signals passing between the set top box 126 associated with the television 110 to which the standby power controller 100 is providing power, and its associated set top box remote control 120. This could be achieved by including the standby power controller 100 in the “pairing” between the remote control 120 and the set top box 126. This requires that a mechanism exist which allows the addition of a new device to the pairing arrangement. Further, the pairing process must be undertaken. This might require the standby power controller 100 to have either or both of a keyboard and a display screen. In many cases, pairing is necessary to determine the commands being carried between the devices, since the operative parts of a signal—the payload—may be encrypted, and thus only accessible to paired devices.

In order to detect user-initiated control of the set top box 126, the RF Sensor 131 detects the existence of a signal between the remote control 120 and the associated set top box 126. To do this, it is only necessary to identify that a signal is passing between the two devices; the detail of the payload need not be known. The identity of the sending and receiving devices will be in the header of a signal between the devices rather than the encrypted payload. Since the header must be read by any device in order to decide if the message should be received, the header is not encrypted, and may be read by a device which is not in a pairing relationship with the set top box 126 or the remote control 120.

FIG. 2 is an illustration of the process by which the RF sensor 131 identifies the signals indicating that there is a signal passing between a remote control and the associated set top box, which may indicate user-initiated control of the set top box.

FIG. 2a shows a block diagram of an RF packet 201, used in the communication protocol between a set top box and an associated remote control. The packet 201 has a packet header 202 and a payload 203. The packet header is used by devices using the protocol to determine which packets are of relevance. The packet header is not encrypted, since it must be able to be read by any device using the protocol in order to determine if the packet is addressed to the device.

The packet 201 includes a payload 203. The payload is the command information which is to be communicated between the remote control and the set top box. It may include, for example, commands such as a command to change the channel which is being displayed on an associated television, or to change the volume of the audio being played. The payload 203 is in general encrypted, but this is not essential.

The header 202 includes two address fields. These are SRC ADR 204 and DEST ADR 205. SRC ADR 204 is an identifier associated with the device which transmitted the packet, and DEST ADR 205 is an identifier associated with the device which is intended to receive the packet, decrypt the payload, and make use of the command information.

Each device which makes use of the RF protocol has an associated identifier or address. When a packet is transmitted, the transmitting device places the address associated with itself in the SRC ADR field. The identifier of the device for which the packet is intended is placed in the DEST ADR field.

Each device using the protocol receives all protocol packets. The header is examined. Where the DEST ADR field matches a device's own address, the packet is accepted as being intended for the device. The payload is decrypted, and the command information processed.

In order to ensure that devices only act upon commands from sources which the designers of the device intend to be acted upon, and ignore spurious commands, commands directed to other devices, and malicious commands, there is a pairing process which identifies devices to each other, the process being under user or manufacturer control.

The pairing process and the decryption process each require significant intelligence and computing capacity in both devices. The decryption process requires a decryption key. This requires a key exchange during the pairing process. For security reasons, barriers may be placed to prevent pairing with an unknown device.

Having the RF sensor 131 pair with either or both of the remote control 120 and the set top box 100 has technical challenges, and is not necessary for the RF sensor 131 to perform its function.

FIG. 2b shows a block diagram representation of communications between the set top box 126 and one or more remote controls 120, and the detection of relevant RF signals by the RF sensor 131 of the standby power controller 100.

A first remote control device RC1 210 has an identifier or address of ADR=11. There is a set top box STB 230 which has an address ADR=3B. Remote control device RC1 210 is the primary remote control for the set top box STB 230. The two devices are paired. The devices communicate by the exchange of protocol packets 211, 214.

Commands sent from remote control device RC1 210 to the set top box STB 230 are in the form of the protocol packet 211. The source address SRC ADR 213 in the protocol packet is set to 11, this being the address of remote control device RC1 210. The destination address 212 is set to 3B, this being the address of the set top box STB 230.

The set top box STB 230 replies to remote control device RC1 210 using packets of the form of protocol packet 214. In this case the source address SRC ADR 216 is set to 3B, the address of the set top box STB 230, and the destination address DEST ADR 215 is set to 11, the address of remote control device RC1 210.

In order for a standby power controller 240 to use an RF sensor to monitor the traffic between remote control device RC1 210 and the set top box STB 230, the standby power controller 240 must identify one or both of remote control device RC1 210 and the set top box STB 230. Preferably, the standby power controller identifies the set top box STB 230. Traffic with a DEST ADR equal to the address of the set top box STB 230 is determined to be relevant, and detection of such traffic is indicated as RF detection by the RF sensor of the standby power controller 240.

In order to identify the address of the set top box STB 230 the standby power controller 240 performs a set up operation. This need only be done once. The standby power controller 240 enters a set up mode, preferably in response to a user control operation, such as operation of a physical switch or in response to other user input, or in response to a command from a software controller such as a control app.

Whilst the standby power controller 240 is in set up mode, the user is instructed to operate a control on the remote control RC1 210. This causes a stream of packets 211 to be transmitted. These packets are received by the RF sensor of the standby power controller 240. The standby power controller is able to read the packet headers to determine the destination address DEST ADR 212. The standby power controller 240 determines that a number of packets with identical destination address values have been received in rapid succession. This indicates that the address of the set top box STB 230 may be identified. The DEST ADR, in the illustrated version 3B, is stored by the standby power controller 240 as the relevant address, being the address of the device whose usage the standby power controller 240 will monitor. Any subsequent packets received with the relevant address will be identified as relevant and the RF sensor will indicate that traffic has been detected. Traffic without the relevant address will be ignored.

The action of the standby power controller 240 in identifying relevant RF traffic is illustrated by the presence of a further remote control RCx 250. RCx 250 is a remote control using the same frequency and protocol employed by remote control RC1 210 and the set top box STB 230. Remote control RCx 250 may be the remote control for another device in the same household, or a remote control used in an adjacent household. The radio signals from remote control RCx 250 are received by the set top box STB 230 and by the RF sensor of the standby power controller 240. Remote control RCx 250 is not paired with set top box STB 230 and does not control the set top box STB 230.

Remote control RCx 250 communicates with the device which it controls via protocol packets 251. These packets 251 are the same type of packets 211 as sent by remote control RC1 210, containing a source address 252 and a destination address 253 which are unencrypted, and an encrypted payload. The destination address DEST ADR 253 is set to the value 1C, the address of the device which remote control RCx 250 controls.

The set top box STB 230 will receive the packet 251, and will read the unencrypted destination address 253 with the value 1C. This value is compared to the value of the relevant address stored by the set top box STB 230 during the set up phase, in this case 3B. Since the destination address 251 does not match the stored relevant address, the RF sensor will not indicate that RF has been detected, and the packet 251 from remote control RCx 250 will be ignored. This ensures that RF traffic which in not relevant to determining whether the set top box STB 230 is in use by a user is ignored.

Referring to FIG. 2b, an optional second remote control RC2 220 is also paired with the set top box STB 230. The address of second remote control RC2 220 is ADR=15. Second remote control RC2 220 and the set top box STB 230 communicate by the exchange of protocol packets 221, 224.

Commands sent from second remote control RC2 220 to the set top box STB 230 are in the form of the protocol packet 221. The source address SRC ADR 223 in the protocol packet is set to 15, this being the address of second remote control RC2 220. The destination address 222 is set to 3B, this being the address of the set top box STB 230.

The set top box STB 230 replies to second remote control RC2 220 using packets of the form of protocol packet 224. In this case the source address SRC ADR 226 is set to 3B, this being the address of the set top box STB 230, and the destination address DEST ADR 225 is set to 15, this being the address of second remote control RC2 220.

It can be seen that the value of DEST ADR in packet 221 is 3B, the same as for packet 211 used for communication to the set top box STB 230 by remote control RC1 210. The relevant destination address stored by the standby power controller is the address of the set top box STB 230 being 3B. Thus, packets 224 will also be detected by the set top box STB 230 as being relevant packets indicating use by a user of the set top box STB 230, without any further set-up being required.

Alternatively, the set top box STB 230 may identify the remote control device during the set-up phase. The set top box STB 230 may then detect relevant RF traffic as either or both of any traffic with a source address corresponding to remote control RC1 210, and any traffic with a destination address corresponding to remote control RC1 210. In this case operation of second remote control RC2 220, if present, will be ignored by the RF sensor.

In some installations, there is significant communication between the set top box and the remote control device which is not user-initiated. This is RF traffic which is not a result of a user interacting with the set top box via the RF remote control device. This traffic may be traffic which communicates information in order to keep the set top box and the remote control synchronized and continuing to communicate on the same RF channel. It may be traffic which maintains the link between the remote control and the set top box by indicating to each device that the other is still active and in range. This traffic does not occur as a result of a user using the set top box, nor is it a result of a user operating the remote control device to control the set top box. This traffic may be referred to as housekeeping traffic.

In order for detection of RF traffic to be effective in detecting user-initiated control of the set top box, traffic which is not related to user-initiated control of the set top box must be at least substantially distinguished and ignored. This can be achieved where the traffic to be ignored has a characteristic which may be detected without the need to read the payload of the traffic packet or packets. In some installations this characteristic may be a temporal distribution, that is, the distribution of the signals over a period of time.

In an example, housekeeping traffic passes between the set top box and the paired remote control on a regular time schedule, being every 12 seconds. Other time periods occur in other versions. Determining that the timing of a detected signal fits this pattern allows the sensor to determine with a high degree of confidence that the signal is housekeeping traffic and to ignore that signal.

In other versions, other characteristics of the housekeeping traffic may be detected, including (for example) the size of the payload, which may be unique or nearly unique to the housekeeping traffic.

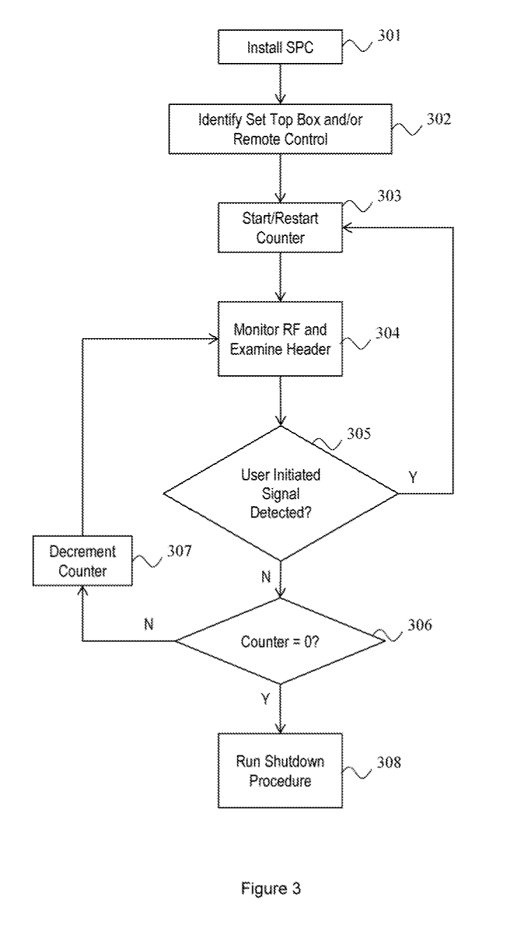

FIG. 3 is a flowchart of the operation of a standby power controller incorporating the invention.

The standby power controller is installed at 301, providing power to a television via the Controlled Outlet. The set top box may be powered from the Always On outlet or from a separate power source.

It is necessary for the standby power controller to identify the set top box remote control which the RF Sensor will be detecting. This may be done by any convenient means, including direct data entry of identifying codes to the standby power controller. In a preferred version, the standby power controller enters a set-up mode immediately after power up, or upon a control operation, such as a user's pushing a button. When the standby power controller is in the set-up mode, the RF Sensor detects any available RF activity. The user is instructed to use the set top box remote control while the standby power controller is in the set-up mode. The RF Sensor detects the signal, which includes one or more protocol packets as described in FIG. 2. The RF sensor extracts the identifiers which identify the source and destination of the packet from the protocol packet. These identifiers identify the set top box and/or the remote control device. The identifiers are recorded and thereafter the RF Sensor will only process a received message to determine if it indicates a user-initiated control of the set top box when the detected message has those identifiers.

The standby power controller then commences monitoring usage of the television and set top box. The standby power controller starts a counter at 303 to count the time during which the set top box remote control remains unused. The counter may be set to any convenient period, for example one hour. The period set may be determined at manufacture, or may be set by a user.

The RF Sensor then monitors for any RF signal at 304. Any detected signal is examined to determine if the signal includes the stored identifiers. A signal which includes the stored identifiers is known to be a signal travelling between the set top box and the RF remote control.

At 305, a determination is made as to whether user-initiated control of the set top box has been detected. In the first instance it is determined that RF from the remote control being monitored has been detected. This determination is made in the manner described in the description of FIG. 2, by determining that the identifiers in the protocol packet in the signal are those of the set top box and the remote control being monitored. When RF from the remote control being monitored is detected, further analysis is applied to determine whether the signal is a housekeeping message. Where the signal is determined to be user-initiated control of the set top box, the RF sensor indicates that such a detection has been made.

Where such user-initiated control has been detected, this indicates that the set top box (and hence the television) remain in active use. The counter is reset at 303, and the process repeats.

Where no user-initiated control of the set top box is detected, a check is made at 306 to check if the counter value is zero. Where the counter value is not zero, the counter is decremented at 307, and the process continues at 304 with the RF Sensor monitoring for RF signals.

Where the counter is determined to have reached zero, this will mean that the remote control has remained unused for a sufficient period to indicate that the television is in active standby, that is, the television is on, but is not being actively watched. The standby power controller will then begin at 308 the procedure to remove power from the Controlled Outlet, thus shutting down the television to save energy.

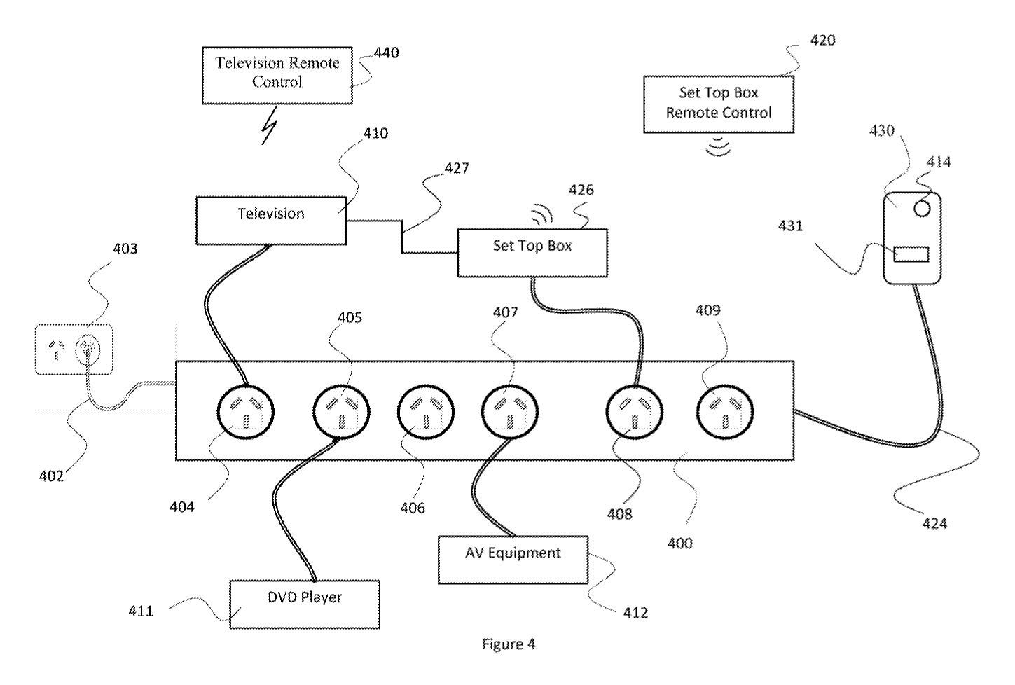

FIG. 4 provides a representation of an alternative version of the invention. A standby power controller 400 includes Controlled Outlets 404, 405, 406, 407. The standby power controller also includes Always On Outlets 408, 409. In general, any number of Controlled Outlets and Always On Outlets may be provided. The Always On Outlet may be absent.

Always On Outlets 408, 409 provide power to devices connected to those outlets at all times when power is supplied to the standby power controller 400 from the General Purpose Outlet 403.

Controlled Outlet 404 supplies electrical power to a television 410. Further Controlled Outlets 405, 406, 407 may provide electrical power to other audio-visual equipment, for example, a DVD player 411 and audio equipment 412. Multiple devices may be powered from one of the Controlled Outlets using a powerstrip.

Always On Outlet 408 provides power for a set top box 426. The set top box 426 has a video connection 427, e.g., a HDMI connection, to the television 410. The video connection 427 allows the set top box video output to be displayed to a user on the television 410. HDMI or any other suitable wired or wireless protocol able to carry a video signal may be used.

A user uses a set top box remote control 420 to control the set top box 426, for example, to select the particular television channel to be displayed on the television 410. Other characteristics of the video to be displayed by the television 410, such as the volume of the sound, may also be controlled by the set top box remote control 420.

The set top box remote control 420 communicates with the set top box 426 via radio frequency (RF) signals. Any suitable protocol may be used. In a preferred version, the set top box remote control 420 communicates with the set top box 426 using the RF4CE protocol.

The television 410 is associated with a television remote control 440. The television remote control 440 employs infra-red (IR) signalling to control the television 410.

The standby power controller 400 includes a sensor unit 430, which includes an RF Sensor 431. The RF Sensor 431 is able to detect the RF communication between the set top box remote control 420 and the set top box 426. The RF Sensor 431 functions in the same way as that described in the description of FIG. 1 in order to detect user-initiated control of the set top box 426. The Sensor Unit 430 includes an IR Sensor 414. The IR Sensor 414 is able to detect the IR communication between the television remote control 440 and the television 410.

It is likely that a user, when actively watching television, will periodically use a remote control to change channels, adjust volume, mute commercials, etc. A remote control signal receiver can therefore be used as a usage sensor.

Where both a television remote control 440 and a set top box remote control 420 are provided, either or both may be used by a user. Detection of usage of either remote control device is indicative that the television 410 is in active use.

If no remote control activity from either remote control 420 or 440 is detected for a period of time, it may be assumed that the television 410 is not in use. The television 410 will be determined to be in an Active Standby state, and the standby power controller 400 acts to control a switch such that power supply to the Controlled Outlet 404, and hence to the television 410, is interrupted. The determination of the Active Standby state may be achieved by using a countdown timer which starts from a specific initial value equal to a particular time period, say one hour, and having this countdown time continuously decrement. Each detected use of a remote control will reset the countdown timer to the initial value. When the countdown time reaches zero, there has been no remote control activity for the time period, the television 410 is assumed to not be in active use, and the electricity supply to the Controlled Outlet 404 (and hence to the television 410) is interrupted.

The Sensor Unit 430 is in data communication with the body of the standby power controller 400 via cable 424, which may also provide power to the sensor unit 430. The cable 424 may be a fixed connection, or may be plug connected at one or both ends. In an alternative version, the sensors in the Sensor Unit 430 may be integrated in the standby power controller body. In any version, the processing function required to analyze the signals detected by the sensors may be provided as an integral part of the sensors 414, 431 or the sensor unit 430, or may be provided in the body of the standby power controller 400.

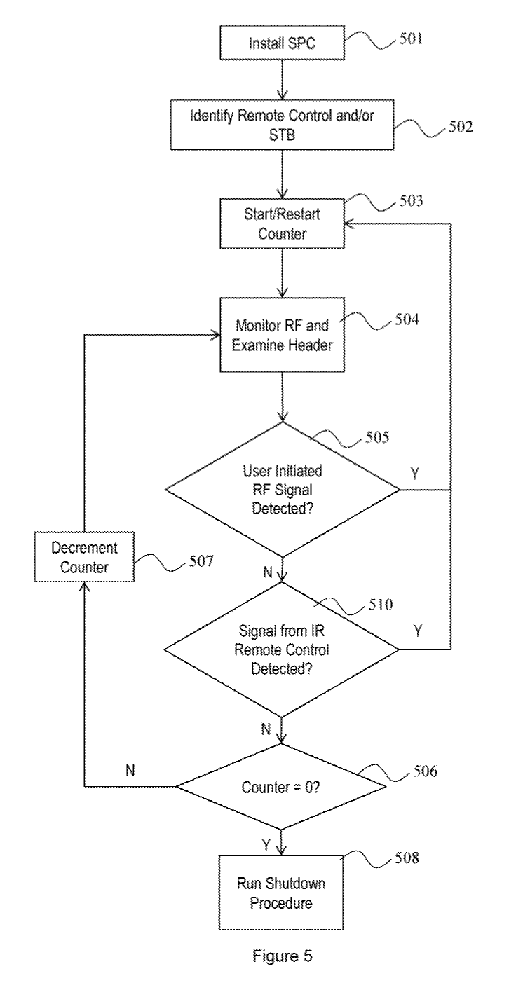

FIG. 5 is a flowchart of exemplary operations of the standby power controller 430, with IR and RF sensors as illustrated in FIG. 4.

The standby power controller is installed at 501, providing power to a television via the Controlled Outlet. The set top box may be powered from the Always On outlet or from a separate power source.

The standby power controller must be able to identify the set top box remote control which the RF Sensor will be detecting. This may be done by any convenient means, including direct data entry of identifying codes into the standby power controller. In a preferred version, the standby power controller enters a set-up mode immediately after power-up, or upon a control operation, such as a user's pushing a button. When the standby power controller is in the set-up mode, the RF Sensor detects any available RF activity. The user is instructed to use the set top box remote control while the standby power controller is in the set-up mode. The RF Sensor detects the signal, and extracts the identifiers which identify the source and destination of the signal from the message. These identifiers are recorded and thereafter the RF Sensor will only further analyze the signal when the detected message has those identifiers. When RF from the remote control being monitored is detected, further analysis is applied to determine whether the signal is a housekeeping message, as described in FIG. 2. Housekeeping messages are ignored. Where the signal is determined not to be a housekeeping message, but to be user-initiated control of the set top box, the RF sensor indicates that such a detection has been made.

The standby power controller then commences monitoring usage of the television and set top box. The standby power controller starts a counter at 503 to count the time during which the set top box remote control remains unused. The counter may be set to any convenient period, for example one hour. The period set may be determined at manufacture, or may be set by a user.

The RF Sensor then monitors for any RF signal at 504. Any detected signal is examined to determine if the signal includes the stored identifiers. A signal which includes the stored identifiers is known to be a signal travelling between the set top box and the RF remote control.

A determination is made at 505 as to whether user-initiated RF control of the set top box has been detected. This determination is made in the manner described in the description of FIG. 2, by determining that the identifiers in the protocol packet in the signal are those of the set top box and the remote control being monitored. When RF from the remote control being monitored is detected, further analysis is applied to determine whether the signal is a housekeeping message. Where the signal is determined to be user-initiated control of the set top box, the RF sensor indicates that such a detection has been made.

Where such user-initiated control has been detected, this indicates that the set top box and hence the television remain in active use. The counter is reset at 503 and the process repeats.

Sequentially or in parallel with the check for RF activity, a check 510 is made for IR activity. This is a check for user interaction with the television via the television remote control. A user may interact with the television via the television remote control either separately from the use of the set top box remote control, or in parallel with such use. For example, even in the presence of a set top box, the television may be receiving a separate broadcast signal. When a user is watching programming provided by this broadcast signal, the user will use the television remote control exclusively. In another example, a user may be watching programming provided by a signal from the set top box, and will thus use the set top box remote control for such functions as channel selection. However, the user may prefer to vary the volume of the program via the television remote control.

The television is determined to be in Active Standby when no user is actively concerned with the television, as determined by interaction with the television. Where both types of remote control devices are in use, it is preferable to detect use of both types of remote control in order to avoid incorrect determination of Active Standby.

Where the check for IR activity indicates that IR activity has taken place, the television is in active use. The counter is reset 503 and the process repeats.

Where both checks for IR and RF remote control use activity are negative, a check is made at 506 to check if the counter value is zero. Where the counter value is not zero, the counter is decremented at 507, and the process continues at 504 with the RF Sensor monitoring for RF signals.

Where the counter reaches zero, this will mean that the remote control has remained unused for a sufficient period to indicate that the television is in active standby, that is, the television is on, but is not being actively watched. The standby power controller will then begin the procedure to remove power from the Controlled Outlet at 508, thus shutting down the television to save energy.

The standby power controller may include a power sensor adapted to sense the power drawn through the Controlled Outlet(s). The power sensor detects characteristics of the power flow through the outlet. When the characteristic is such as to indicate that the television is in a standby mode the power to the Controlled Outlet, and hence to the attached television or monitor is interrupted.

Where there are multiple Controlled Outlets, the standby power controller may operate to remove power from all of the Controlled Outlets together, removing power from all connected audio visual equipment which will not be in use if the television is not in use.

The power drawn through all of the Controlled Outlets in aggregate might be monitored. The power might then be removed from the Controlled Outlets only when the characteristics of the aggregate monitored power draw indicates that all devices connected to any Controlled Outlet are in standby.

The standby power controller may include any number of Controlled Outlets, which may be monitored individually, in groups or in aggregate to determine characteristics of the power drawn through the outlets by the connected appliances. The power to the Controlled Outlets is controlled by the standby power controller and power may be withdrawn from these outlets either individually, in groups, or from all Controlled Outlets simultaneously.

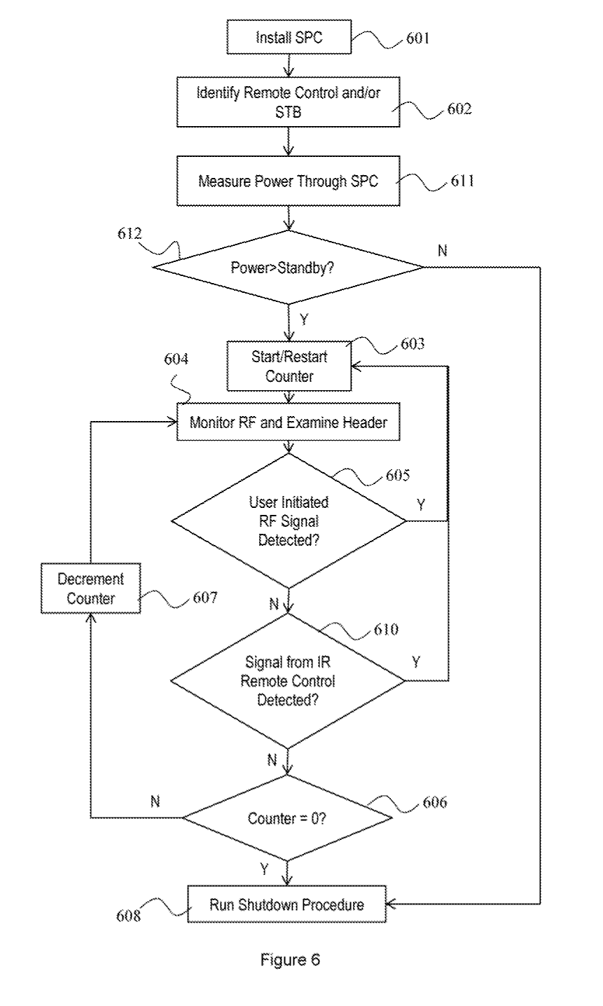

FIG. 6 is a flowchart of the exemplary operation of a standby power controller in accordance with the invention. The standby power controller has IR and RF sensors as illustrated in FIG. 4, as well as a power sensor.

The standby power controller is installed at 601, providing power to a television via the Controlled Outlet. The set top box may be powered from the Always On outlet or from a separate power source.

The standby power controller must identify the set top box remote control which the RF Sensor will be detecting, a step illustrated at 602. This may be done by any convenient means, including direct data entry of identifying codes to the standby power controller. In a preferred version, the standby power controller enters a set-up mode immediately after power up, or upon a control operation, such as a user's pushing a button. When the standby power controller is in the set-up mode, the RF Sensor detects any available RF activity. The user is instructed to use the set top box remote control while the standby power controller is in the set-up mode. The RF Sensor detects the signal, and extracts the identifiers from the message. These identifiers are recorded and thereafter the RF Sensor will only indicate detection of RF when the detected message has those identifiers.

The standby power controller then commences monitoring the power usage of the television. Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

The power draw of the television is measured at 611 by a power sensor associated with the Controlled Outlet, and is used to determine the power state of the television. A significant drop in the magnitude of the power draw may be used to determine that a low power standby mode has been entered. Threshold values of power consumption may be used to determine the power state of the television, with any value below a threshold being interpreted as indicating that the television is in a standby power state. Other characteristics of the power use may be used to determine that the television is not in use. This may be the presence, absence, or a defined pattern of small fluctuations of the power draw.

The characteristics of the measured power are examined at 612. If the measured power is below the threshold value, or the power characteristics are otherwise such as to indicate that the television is in a low power standby mode, the standby power controller will commence the procedure to remove power from the Controlled Outlets at 608.

The standby power controller then commences monitoring usage of the television and set top box. The standby power controller starts a counter at 603 to count the time during which the set top box remote control remains unused. The counter may be set to any convenient period, for example one hour. The set period may be defined at manufacture, or may be set by a user.

The RF Sensor then monitors at 604 for any RF signal. Any detected signal is examined to determine if the signal includes the stored identifiers. A signal which includes the stored identifiers is known to be a signal travelling between the set top box and the RF remote control.

A determination is made at 605 as to whether user-initiated control of the set top box has been detected. A determination as to whether RF has been detected from the monitored remote control is made in the manner described in the description of FIG. 2, by determining that the identifiers in the protocol packet in the signal are those of the set top box and the remote control being monitored. When RF from the monitored remote control is detected, further analysis is applied to determine whether the signal is a housekeeping message. Where the signal is determined to be user-initiated control of the set top box, the RF sensor indicates that such a detection has been made. This indicates that the set top box, and hence the television, remain in active use. The counter is reset at 603 and the process repeats.

Sequentially or in parallel with the check for RF activity, a check is made at 610 for IR activity. This is a check for user interaction with the television via the television remote control. A user may interact with the television via the television remote control either separately from the use of the set top box remote control, or in parallel with such use. For example, even in the presence of a set top box, the television may be receiving a separate broadcast signal. When a user is watching programming provided by this broadcast signal, the user will use the television remote control exclusively. In another example, a user may be watching programming provided by a signal from the set top box, and will thus use the set top box remote control for such functions as channel selection. However, the user may prefer to vary the volume of the program via the television remote control.

The television is determined to be in Active Standby when no user is actively concerned with the television, as determined by interaction with the television. Where both types of remote control devices are in use, it is preferable to detect use of both types of remote control in order to avoid incorrect determination of Active Standby.

Where the check for IR activity indicates that IR activity has taken place, the television is in active use. The counter is reset at 603 and the process repeats.

Where both checks for IR and RF remote control use activity are negative, a check is made at 606 to check if the counter value is zero. Where the counter value is not zero, the counter is decremented at 607, and the process continues at 604 with the RF Sensor monitoring for RF signals.

Where the counter reaches zero, this will mean that the remote control has remained unused for a sufficient period to indicate that the television is in active standby, that is, the television is on, but is not being actively watched.

The standby power controller will then begin the procedure at 608 to remove power from the Controlled Outlet, thus shutting down the television to save energy.

Monitoring of power state and usage of each of the types of remote control may be carried out sequentially or in parallel.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the power control function of the standby power controller being bypassed, preventing power savings.

When the standby power controller determines that the television is in active standby, a warning signal may be provided (e.g., a warning LED may flash) to alert any user to the imminent shutdown of the power to the television. In the case where there is a false positive, that is, there is a user watching the television, the user may react to the warning signal by pressing a key on either the set top box remote control or the television remote control. The IR or RF user-initiated control signal from the remote control is detected by the sensor unit, and the countdown timer is reset, preventing interruption of the power to the television. A separate control on the standby power controller (such as a press button) may also be provided, the operation of which will also prevent shutdown.

Other methods for warning of imminent shutdown of power to the television may be used, such as an audible warning tone.

Devices other than a television may be connected along with a television to the Controlled Outlets. In this case, the total load of all devices can be monitored for the characteristics indicating that all devices so connected are in a standby or unused state.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the Controlled Outlets, power is also interrupted to this outlet.

Where the terms “substantially,” “primarily,” and the like are used, these should be regarded as meaning “in major part.” For example, if remote control activity is recognized substantially only when that activity is user-initiated, this means that remote control activity is recognized only when over 50% of such activity is user-initiated.

It should be understood that the versions of the invention described above are merely exemplary, and the invention is not intended to be limited to these versions. Rather, the scope of rights to the invention is limited only by the claims set out below, and the invention encompasses all different versions that fall literally or equivalently within the scope of these claims.

What is claimed is:

1. A standby power controller including:
a. an electrical outlet which supplies electrical power to a television, the television being configured to display a video signal provided by a set top box;
b. a remote control sensor configured to:
(1) sense use of a remote control device, the remote control device being for user-initiated control of the set top box;
(2) distinguish between:
(a) user-initiated control signals travelling between the remote control device and the set top box, the user-initiated control signals being associated with user-initiated control of the set top box, and
(b) non-user-initiated control signals travelling between the remote control device and the set top box, the non-user-initiated control signals not being associated with user-initiated control of the set top box;
wherein the standby power controller removes power from the electrical outlet when the remote control sensor does not detect user-initiated control signals during a selected time period.

2. The standby power controller of claim 1 wherein:
a. non-user-initiated control signals differ from user-initiated control signals by one or more known characteristics which are detectable without knowledge of command content encoded within the signals; and
b. the standby power controller ignores signals having the known characteristics.

3. The standby power controller of claim 2 wherein the known characteristics are that the non-user-initiated control signals have a known temporal distribution.

4. The standby power controller of claim 2 wherein:
a. the known characteristics are that the non-user-initiated control signals have a known payload size which differs from the payload size of at least a majority of user-initiated control signals, and
b. the standby power controller ignores signals having the known payload size.

5. The standby power controller of claim 1 wherein:
a. non-user-initiated control signals have a known temporal distribution, and
b. the standby power controller ignores signals having the known temporal distribution.

6. The standby power controller of claim 1 wherein the remote control sensor distinguishes user-initiated control signals from non-user-initiated control signals by detecting usage of a wireless protocol used by the remote control device to communicate control commands to the set top box.

7. The standby power controller of claim 1 wherein:
a. the remote control device and the set top box communicate via a wireless protocol which includes pairing between devices in order to permit communication between the devices, and
b. the remote control sensor:
(1) senses use of the remote control device only by detection of signals passing between the remote control device and the set top box paired with the remote control device,
(2) is not paired with either the remote control device or the set top box.

8. The standby power controller of claim 7 wherein:
a, the wireless protocol includes packets having an unencrypted header and an encrypted payload, and
b. the standby power controller determines that control signals are a communication between the remote control device and the set top box:
(1) using information contained in the header, and
(2) not using information contained in the payload.

9. The standby power controller of claim 7 wherein:
a. the wireless protocol:
(1) includes an address for each device addressable by another device using the protocol,
(2) communicates packets between devices, wherein each packet directed to a device includes the address of the device in a packet header of the packet,
b. the standby power controller is configured to determine the address of the set top box without pairing with the set top box or any remote control device.

10. The standby power controller of claim 1 wherein the remote control sensor is further configured to detect an infra-red signal from a television remote control device associated with the television.

11. The standby power controller of claim 10 wherein the standby power controller removes power from the electrical outlet only when:
a. the remote control sensor does not detect user-initiated control signals during the selected time period, and
b. the remote control sensor does not detect an infra-red signal from the television remote control device during a selected second time period.

12. A standby power controller including:
a. an electrical outlet which supplies electrical power to a television, the television being configured to display a video signal provided by a set top box, and
b. a remote control sensor configured to sense use of a remote control device, the remote control device being configured for user-initiated control of the set top box,
wherein the standby power controller removes power from the electrical outlet when the remote control sensor does not sense user-initiated control signals emitted from the remote control device during a selected time period, the user-initiated control signals:
(1) encoding an address identifying the set top box, and
(2) lacking one or more of:
(a) a temporal distribution, and
(b) a payload size,
corresponding to non-user-initiated control signals emitted from the remote control device.

13. The standby power controller of claim 12 wherein the user-initiated control signals contain data packets, each packet having a header and a payload, wherein:
a. the address identifying the set top box is encoded within the header, and
b. a command to the set top box is encoded in the payload.

14. The standby power controller of claim 12 wherein the remote control sensor is further configured to sense an infra-red signal from a television remote control device associated with the television.

15. The standby power controller of claim 14 wherein the standby power controller removes power from the electrical outlet only when:
a. the remote control sensor does not detect user-initiated control signals during the selected time period, and
b. the remote control sensor does not detect an infra-red signal from the television remote control device during a selected second time period.

16. A method for saving energy by removing power from a television which displays a video signal from a set top box when the television is not being actively watched by a user, the method including the steps of:
a. detecting user-initiated control of the set top box by detecting use of a first wireless remote control configured to control the set top box;
b. when the user-initiated control is not detected during a selected period of time, removing power from the television.

17. The method of claim 16 wherein the detecting step further includes:
a. determining an address of the set top box within a wireless protocol used to communicate between the set top box and the remote control;
b. monitoring communications in the vicinity of the set top box which use the wireless protocol;
c. examining address information in the monitored communications;
d. upon determining that at least one of the monitored communications:
(1) includes the address of the set top box, and
(2) is a user-initiated control of the set top box, restarting the selected period of time.

18. The method of claim 16 further including the steps of:
a. detecting use of a second wireless remote control configured to control the television;
b. removing power from the television when:
(1) use of the first remote control is not detected during the selected period of time, and
(2) use of the second remote control is not detected during the selected period of time.
